(19) United States
(12) Patent Application Publication
(10) Pub. No.: US 2017/0370268 A1
(43) Pub. Date: Dec. 28, 2017

(54) METHOD AND DEVICE FOR MONITORING THE OPERABILITY OF AN EMISSION CONTROL SYSTEM

(71) Applicant: Robert Bosch GmbH, Stuttgart (DE)

(72) Inventors: Frank Meier, Stuttgart (DE); Matthias Blei, Ilsfeld (DE); Michael Pfeil, Marbach Am Neckar (DE); Michael Fey, Wiernsheim (DE)

(21) Appl. No.: 15/634,280

(22) Filed: Jun. 27, 2017

(30) Foreign Application Priority Data
Jun. 27, 2016 (DE) 102016211506.5

(51) Int. Cl. F01N 11/00; F01N 3/10; F01N 3/035; G01M 15/10; F01N 13/00

(52) U.S. Cl. CPC F01N 11/00; G01M 15/104; F01N 13/008; F01N 3/035; F01N 3/10; F01N 2550/02

(57) ABSTRACT

In a method and a device for monitoring the operability of an emission control system of an internal combustion engine, at least two catalytic converters are situated in succession in an exhaust duct. For tracking control, breakthrough detection for diagnosing the first catalytic converter, and for a second balancing for the storage capacity of oxygen or rich gas of the second catalytic converter, a two-point lambda probe be used and, for the latter, tolerance and aging effects are compensated. This results in particular in cost advantages in emission control systems for fulfilling stricter emission and diagnostic requirements.

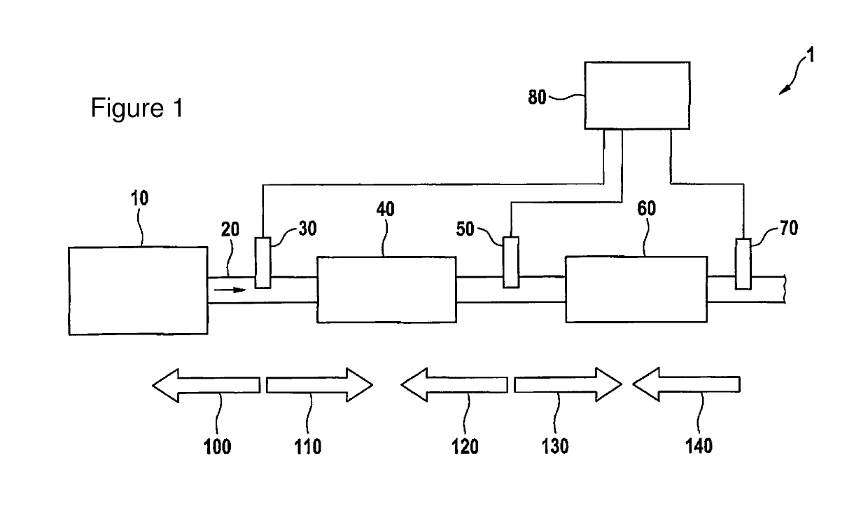

### CROSS-REFERENCE TO RELATED APPLICATIONS

The present application claims priority under 35 U.S.C. §119 to DE 10 2016 211 506.5, filed in the Federal Republic of Germany on Jun. 27, 2016, the content of which is hereby incorporated by reference herein in its entirety.

### FIELD OF THE INVENTION

The present invention relates to a method for monitoring the operability of an emission control system of an internal combustion engine, which has in its central section at least two catalytic converters situated in succession, it being possible for additional exhaust gas-purifying components to be situated upstream or downstream from this central section, a lambda probe being situated behind an engine block and in front of the first catalytic converter in the direction of flow of the exhaust gas and another exhaust-gas probe being situated respectively downstream from the first and downstream from the additional catalytic converter, and a lambda control as well as a balancing for the storage capacity for oxygen or rich gas of the first catalytic converter being performed using the lambda probe and a catalytic converter diagnosis of the additional catalytic converter being performed using a lambda probe behind the additional catalytic converter which is designed as a two-point lambda probe. The present invention furthermore relates to a device, in particular an engine control unit, for implementing the method.

### BACKGROUND

In today's engine control systems, lambda probes are used for detecting the concentration of oxygen in the exhaust gas and for the lambda control of the engine. Wide-band lambda probes and two-point lambda probes are used for this purpose.

A wide-band lambda probe makes it possible to control the exhaust-gas lambda continuously in a broad lambda range. By a linearization of the probe characteristic, a continuous lambda control is also possible using a more cost-effective two-point lambda probe, even if in a limited lambda range.

Compared to a wide-band lambda probe, a two-point lambda probe has a significantly higher accuracy in a narrow range around lambda=1 due to its stepwise probe characteristic. Outside of this narrow range around lambda=1 at rich or lean lambda, the accuracy of a two-point lambda probe is normally less than that of a wide-band lambda probe due to tolerance and aging effects.

Normally, for this reason, wide-band lambda probes are used in engine control systems where rich or lean lambda values are to be measured accurately or where a measurement in the range around lambda=1 with limited accuracy is sufficient. Two-point lambda probes are used where the exhaust-gas lambda in the range around lambda=1 is to be measured with great accuracy.

Typical applications for a wide-band lambda probe are the lambda control upstream from the catalytic converter and the balancing of the oxygen input and discharge in the diagnosis of the catalytic converter. Typical applications of a two-point lambda probe are the very accurate lambda=1 control downstream from the catalytic converter and the detection of the breakthrough of rich or lean exhaust gas in the diagnosis of the catalytic converter.

A typical exhaust system of a gasoline system for today's strict emission and diagnostic requirements, e.g., in so-called “super ultra-low emission vehicles” (SULEV) is made up of a wide-band lambda probe, a first three-way catalytic converter, a two-point lambda probe, and a second non-monitored three-way catalytic converter.

Future emission and diagnostic requirements that are even stricter (e.g., probably China 6) require exhaust systems, in which also the function of the second three-way catalytic converter is monitored and its oxygen storage capacity is measured. The second three-way catalytic converter can also exist in the form of a combination with a particulate filter or as a combination of both components in one, which is also called a coated particulate filter or a four-way catalytic converter. Combinations of the second three-way catalytic converter with other catalytic converters, e.g., with an NSC or SCR catalytic converter, are also possible.

From the standpoint of monitoring the oxygen storage capacity of the second catalytic converter as accurately as possible, it seems expedient to use a wide-band lambda probe upstream from this second catalytic converter for balancing the oxygen input and discharge and to use downstream from this second catalytic converter a two-point lambda probe for detecting the breakthrough of rich or lean exhaust gas in the diagnosis.

Currently, therefore, exhaust systems (situated behind the engine block in the direction of flow of the exhaust gas in the exhaust duct) are being discussed, which include the following: a first wide-band lambda probe; a first catalytic converter (implemented as a three-way catalytic converter); a second wide-band lambda probe; a second catalytic converter (or coated particulate filter); and a two-point lambda probe. The first wide-band lambda probe is used for the lambda control as well as for balancing for the diagnosis of the first catalytic converter, and the second wide-band lambda probe is used for tracking control and for breakthrough detection in the diagnosis of the first catalytic converter as well as for the balancing for the diagnosis of the second catalytic converter. In this system, however, the second wide-band lambda probe has functional disadvantages vis-à-vis a two-point lambda probe in this installation position. These are on the one hand a lower accuracy of the tracking control in the range around lambda=1 and on the other hand a poorer suitability for detecting lambda breakthroughs for the diagnosis of the first catalytic converter.

DE 102013226063 A1 describes for example a system of this kind having two successive catalytic converters, a three-way preconverter and a three-way postconverter. A lambda probe is respectively provided upstream and downstream from the preconverter. A third lambda probe is provided downstream from the postconverter. There is no provision for determining the composition of the exhaust gas upstream from the main catalytic converter for balancing its oxygen or rich gas storage capacity.

### SUMMARY

It is therefore an objective of the present invention to provide a method that makes it possible, in an emission control system having at least two catalytic converters, to use behind the first catalytic converter in the direction of flow of the exhaust gas a more cost-effective two-point lambda probe instead of a second wide-band lambda probe in order to allow with this two-point lambda probe also for a sufficiently accurate diagnosis of the oxygen or rich gas storage capacity of the subsequent catalytic converter. Furthermore, a more accurate tracking control in the range around λ=1 and a more accurate diagnosis of the first catalytic converter are to be achieved.

It is furthermore an objective of the present invention to provide a corresponding device for executing the method.

The objective with respect to the method is achieved in that a first two-point lambda probe is used for the diagnosis of the first catalytic converter and for a balancing for the storage capacity of oxygen or rich gas of the additional catalytic converter and in that, for the first two-point lambda probe, specific measures are taken for compensating tolerance and aging effects. This makes it possible to provide a comparatively simple and cost-effective emission control system.

A preferred variant provides for the lambda probe upstream from the first catalytic converter of the central section of the emission control system to be implemented as a wide-band lambda probe and for the latter to be used for the lambda control and the balancing for the storage capacity of oxygen or rich gas of the first catalytic converter.

Normally, an engine control unit for an exhaust-gas bank does not offer the possibility of using it to operate a second wide-band lambda probe. On the other hand, the possibility of operating a wide-band lambda probe and two two-point lambda probes normally already exists such that no change is required in the hardware of the control units. The use of a two-point lambda probe for the balancing of the oxygen input and oxygen discharge of a catalytic converter presupposes, however, that there is a definite correlation between the probe voltage and the exhaust gas lambda. It is important that this correlation be definite over the entire service life of the probe since otherwise incorrect balancing will result, which may result in false diagnoses. This precondition is usually not fulfilled. For this reason, the application of specific measures for compensating for tolerance and aging effects is particularly important. Altogether, the method according to the present invention is thus better able to fulfill the requirements regarding the accuracy of the tracking control and of the diagnosis of the first catalytic converter. At the same time, the accuracy of the diagnosis of the second catalytic converter is of sufficient quality so as to allow for a reliable distinction between a catalytic converter that is still functioning properly and one that is already defective.

This central section of the emission control system can be part of a more complex emission control system, in which additional exhaust gas-purifying components can be installed upstream or downstream from this central section. Thus, for example, the following arrangements are conceivable: (a) wide-band lambda probe/1st catalytic converter/wide-band lambda probe/2nd catalytic converter/two-point lambda probe/3rd catalytic converter/two-point lambda probe; (b) wide-band lambda probe/1st catalytic converter/two-point lambda probe/2nd catalytic converter/NOₓ catalyst/two-point lambda probe; or (c) wide-band lambda probe/1st catalytic converter/two-point lambda probe/2nd catalytic converter/wide-band lambda probe/3rd catalytic converter/two-point lambda probe/4th catalytic converter/two-point lambda probe.

For the purpose of compensating for tolerance and aging effects, a particularly preferred variant of the method provides for an offset of the probe characteristic of the first two-point lambda probe to be adapted by an adjustment at high excess air when the internal combustion engine is running or is at a standstill. This makes it possible to adapt a two-point lambda probe for the above-mentioned measuring tasks in a particularly cost-effective manner.

In order to increase the accuracy of the balancing of the oxygen or rich gas storage capacity, there can be a provision, for the purpose of compensating tolerance and aging effects, to perform a compensation by shifting the lambda-one point of the probe characteristic of the first two-point lambda probe via a tracking control of the second two-point lambda probe.

An extended compensation of tolerance and aging effects can be achieved if a correction of a temperature-related shift of the probe characteristic is applied with the aid of an active measurement of the sensor element temperature while the internal combustion engine is running or is at a standstill. A large portion of tolerance and aging effects can hereby be corrected. The correction of a temperature-related shift is possible at least when the engine is at a standstill also independently of the compensation of a constant offset and the compensation of the lambda-1 shift.

Additionally, there can be a provision for applying a correction of the calculation of the lambda value for adapting an offset by taking into account a current exhaust-gas composition and a varying cross sensitivity vis-à-vis different exhaust-gas components.

Depending on the required accuracy, there can also be a provision to use previously described corrective measures in combination.

The method previously described with its variants can also be extended to emission control systems that have more than two catalytic converters. For this purpose, a cost-effective balancing of the oxygen or rich gas storage capacity of additional catalytic converters is possible if a two-point lambda probe in emission control systems having more than two catalytic converters is used respectively in the direction of flow of the exhaust gas directly in front of this additional catalytic converter and compensation measures according to the previously described method variants are used for this two-point exhaust gas probe.

A particularly preferred application of the method with its previously described method variants provides for its use for vehicles having at least two successive catalytic converters in an emission control system for maintaining particularly strict exhaust gas guidelines, a catalytic converter being implemented in combination with a particulate filter.

The objective with respect to the device is achieved in that for a tracking control, breakthrough detection for the diagnosis of the first catalytic converter and for a second balancing for the storage capacity of oxygen or rich gas of the second catalytic converter, a first two-point lambda probe is situated upstream from the second catalytic converter and an engine control unit is provided for carrying out the method of the present invention, to which the signals of the different lambda probes are supplied and which includes devices such as storage and/or comparator units, which in addition to a catalytic converter diagnosis also allow for an implementation of measures for compensating tolerance and aging effects of the first two-point lambda probe in accordance with the previously described method variants. The functionality of these functions can be implemented at least in part on the basis of software, e.g., in the form of a control software, it being possible for the control unit to be provided as a separate unit or as part of a higher-order control unit including processing circuitry.

An extended emission control system having three or more catalytic converters can provide for additional two-point lambda probes to be connected to the engine control unit and for these additional two-point lambda probes to be situated in the direction of flow of the exhaust gas in front of a catalytic converter that is to be balanced. This allows for a cost-effective monitoring even of very complex emission control systems.

The present invention is explained in more detail in the following on the basis of an exemplary embodiment shown in the FIGURE.

### BRIEF DESCRIPTION OF THE DRAWINGS

The FIGURE is a schematic representation of an internal combustion engine having an emission control system by which the method of the present invention can be implemented, according to an example embodiment of the present invention.

### DETAILED DESCRIPTION

The FIGURE schematically shows an internal combustion engine 1 that includes an engine block 10, an exhaust duct 20, a lambda probe 30 that is, with respect to the direction of flow of exhaust gas, downstream of the engine block 10 and that is implemented as a wide-band lambda probe, and a first catalytic converter 40 situated downstream of the lambda probe 30. Lambda probe 30 makes possible lambda control 100 and is used for a first balancing 110 for diagnosing the storage capacity of the first catalytic converter.

The internal combustion engine 1 further includes, downstream from first catalytic converter 40, a first two-point lambda probe 50 used for tracking control 120 and for breakthrough detection for the catalytic converter diagnosis of first catalytic converter 40. The internal combustion engine 1 further includes a second catalytic converter 60 downstream of the first two-point lambda probe 50. The first two-point lambda probe 50 is additionally used for a second balancing 130 of the storage capacity of the second catalytic converter 60. Downstream of the second catalytic converter 60, the internal combustion engine 1 further includes a second two-point lambda probe 70 for breakthrough detection for a catalytic converter diagnosis 140 of second catalytic converter 60. Lambda probes 30, 50, and 70 are connected to an engine control unit 80, in which on the one hand the lambda control and on the other hand the diagnostic methods regarding the monitoring of the operability of the emission control system are implemented in hardware and/or software.

The present invention is analogously also applicable to emission control systems having more than two monitored catalytic converters 40, 60, a two-point lambda probe being used for balancing the storage capacity of oxygen or rich gas of the subsequent catalytic converter in the direction of flow of the exhaust gas.

For measuring the oxygen storage capacity of a catalytic converter 40, 60, the latter is first freed completely of oxygen. This is achieved by a preconditioning with a mixture of sufficiently “rich,” i.e., low, lambda (typically λ=0.95). The rich preconditioning occurs in a controlled manner on the basis of the lambda signal of the probe upstream from the catalytic converter. Subsequently, a switch is performed to a mixture with “lean” lambda, i.e., higher lambda (typically λ=1.05). This lambda value too is adjusted by the probe upstream from the catalytic converter.

This lean lambda value is maintained until the lambda probe downstream from the catalytic converter indicates a breakthrough of a lean exhaust gas mixture. The oxygen quantity introduced into the catalytic converter between the switchover to the lean lambda value and the breakthrough of the lean mixture is balanced and corresponds to the oxygen storage capacity of catalytic converter 40, 60. It is possible to apply this method analogously to the determination of the rich gas storage capacity of a catalytic converter 40, 60. Here, following a lean preconditioning where λ>1, the oxygen quantity discharged from catalytic converter 40, 60 during the rich phase, where λ<1, is balanced.

A lambda probe is suitable as a probe upstream from the catalytic converter 40, 60 for adjusting the lambda value in the rich preconditioning and for adjusting the lean lambda value as well as for balancing 110, 130 the entered oxygen quantity during the measurement of the oxygen storage capacity of catalytic converter 40, 60 if it has a sufficiently precise lambda signal in a wide lambda range (typically in a range between λ=0.95 and λ=1.05). A two-point lambda probe 50, 70 does not fulfill this requirement without additional measures.

The use of a first (as shown in the FIGURE) two-point lambda probe 50 for the second balancing 130 for the diagnosis of second catalytic converter 60 presupposes the compensation of tolerance and aging effects, which result in a shift of the actual probe characteristic vis-à-vis the reference probe characteristic stored in the control unit or engine control unit 80. Only then will the lambda signal of this first two-point lambda probe 50 fulfill the mentioned requirements regarding accuracy.

DE102012211687A1, DE102012211683A1, DE102013216595A1, DE102014210442A1 and DE102012221549A1 describe methods that allow for a compensation of tolerance and/or aging effects that result in such a characteristic curve shift. The methods described there, one or more of which, according to example embodiments of the present invention, are applied to the first two-point lambda probe 50 individually or in combination, include: adaptation of a constant offset of the probe characteristic by an adjustment at high excess air while the engine is running or is at a standstill; compensation of the shift of the lambda-one point of the probe characteristic via a tracking control using the second two-point lambda probe 50; compensation of a temperature-related shift of the probe characteristic with the aid of an active measurement of the sensor element temperature while the engine is running or is at a standstill; and taking into account the current exhaust-gas composition and different cross sensitivities of the probe vis-à-vis various exhaust-gas components in the conversion of the probe voltage into a lambda value.

In a particularly preferred variant of the method of the present invention, only a constant offset of the probe characteristic is adapted. This is possible to achieve in a comparatively simple manner by an adjustment at high excess air, such as occurs for example at an overrun fuel cutoff, and in many cases already results in a sufficient accuracy of the lambda signal so as to be able to use it for balancing the oxygen input and discharge for diagnosing the second catalytic converter 60. At the same time, this adaptation improves the accuracy of the breakthrough detection in the diagnosis of first catalytic converter 40 and the accuracy of the tracking control 120 with the aid of the first two-point lambda probe 40.

By combining the adaptation of a constant offset of the probe characteristic with one or more of the above-mentioned methods it is possible to improve the accuracy of the lambda signal of the first two-point lambda probe 50 downstream from first catalytic converter 40 further, in the event that even higher requirements are placed on the accuracy of this lambda signal.

Following the compensation, the lambda signal of the first two-point lambda probe 50 is used, as described above, for the measurement of the oxygen storage capacity of second catalytic converter 60. In the alternative method variant already mentioned above, the lambda signal is used for measuring the rich gas storage capacity. For both measurements, active lambda adjustment, triggered specifically for the catalytic converter diagnosis, and/or the use of lambda adjustment that are already present anyway are provided.

What is claimed is:

1. A method for monitoring an operability of an emission control system of an internal combustion engine that, in its central section includes first and second catalytic converters situated in an exhaust duct in succession, a first lambda probe being situated, with respect to a direction of flow of exhaust gas, downstream of an engine block and upstream of the first catalytic converter, a first exhaust-gas probe being situated downstream of the first catalytic converter and upstream of the second catalytic converter, and a second exhaust-gas probe being situated downstream of the second catalytic converter, wherein the lambda probe is used to perform a lambda control and a balancing for a storage capacity of oxygen or rich gas of the first catalytic converter, and the second exhaust-gas probe is implemented as a first two-point lambda probe and is used to perform a catalytic converter diagnosis of the second catalytic converter, the method comprising:
using the first exhaust-gas probe, which is implemented as a second two-point lambda probe, for a tracking control and breakthrough detection for a diagnosis of the first catalytic converter and for a second balancing for the storage capacity of oxygen or rich gas of the second catalytic converter; and
compensating for tolerances and aging effects of the second two-point lambda probe.

2. The method of claim 1, wherein the lambda probe upstream of the first catalytic converter is a wide-band lambda probe.

3. The method of claim 1, wherein the compensation includes adapting an offset of a probe characteristic of the second two-point lambda probe by an adjustment at high excess air while the internal combustion engine is running or is at a standstill.

4. The method of claim 3, wherein the compensating includes applying a correction of a temperature-related shift of the probe characteristic with the aid of an active measurement of a sensor element temperature while the internal combustion engine is running or is at a standstill.

5. The method of claim 3, wherein the compensating includes correcting a calculation of a lambda value in order to take into account a current exhaust-gas composition and a varying cross sensitivity vis-à-vis different exhaust-gas components.

6. The method of claim 1, wherein the compensating includes shifting a lambda-one point of a probe characteristic of the second two-point lambda probe via a tracking control of the first two-point lambda probe.

7. The method of claim 6, wherein the compensating includes applying a correction of a temperature-related shift of the probe characteristic with the aid of an active measurement of the sensor element temperature while the internal combustion engine is running or is at a standstill.

8. The method of claim 1, wherein the emission control system includes a further catalytic converter and a further two-point lambda probe directly upstream of the further catalytic converter for a balancing of a storage capacity of oxygen or rich gas of the additional catalytic converter and compensation measures are taken for the further two-point exhaust-gas probe.

9. The method of claim 1, wherein the internal combustion engine is part of a vehicle and at least one of the catalytic converters is implemented in combination with a particulate filter.

10. An emission control system of an internal combustion engine, the emission control system comprising:
an engine control unit;
a first catalytic converter situated in an exhaust duct;
a second catalytic converter situated in the exhaust duct in sequence with the first catalytic converter;
a first lambda probe that is situated, with respect to a direction of flow of exhaust gas, downstream of an engine block and upstream of the first catalytic converter, and that is configured to perform a lambda control and a balancing for a storage capacity of oxygen or rich gas of the first catalytic converter, and that is configured to supply signals to the engine control unit;
a first exhaust-gas probe that is downstream of the first catalytic converter and upstream of the second catalytic converter, that is configured to supply signals to the engine control unit, and that is a first two-point lambda probe configured for a tracking control, a breakthrough detection for a diagnosis of the first catalytic converter, and a balancing for a storage capacity of oxygen or rich gas of the second catalytic converter; and
a second exhaust-gas probe that is downstream of the second catalytic converter, that is a second two-point lambda probe, that is configured to perform a catalytic converter diagnosis of the second catalytic converter, and that is configured to supply signals to the engine control unit;
wherein the engine control unit includes a storage device and a comparator unit and is configured to perform a catalytic converter diagnosis and execute measures for compensating tolerance and aging effects of the first two-point lambda probe.

11. The system of claim 10, wherein the emission control system includes a third catalytic converter and a third two-point lambda probe directly upstream of the third catalytic converter for a balancing of a storage capacity of oxygen or rich gas of the third catalytic converter.
